(19) United States
(12) Patent Application Publication
(10) Pub. No.: US 2003/0220428 A1
(43) Pub. Date: Nov. 27, 2003

(54) Rubber mixtures containing quaternary polymers and polar plasticizers

(76) Inventors: Peter Wendling, Leverkusen (DE); Adrian Rawlinson, Leverkusen (DE); Rudiger Engehausen, Dormagen (DE)

Correspondence Address: BAYER POLYMERS LLC, 100 BAYER ROAD, PITTSBURGH, PA, 15205, US

(21) Appl. No.: 10/435,849

(22) Filed: May 12, 2003

(30) Foreign Application Priority Data
May 23, 2002 (DE) 10222887.6

(51) Int. Cl. C08K 5/49; C08K 5/09; C08K 5/04

(52) U.S. Cl. 524/287; 524/115; 524/394

(57) ABSTRACT

The present invention relates to rubber mixtures containing at least one quaternary polymer and at least one polar synthetic plasticizer, to a process for their production and to their use in the production of rubber molded bodies.

### FIELD OF THE INVENTION

The present invention relates to rubber mixtures containing quaternary polymers based on an unsaturated olefinic nitrile, a vinyl aromatic compound, a conjugated diene and a polar polymerizable compound, as well as at least one polar synthetic plasticizer. The rubber mixtures according to the present invention can be used in the production of rubber molded bodies, such as tires.

### BACKGROUND OF THE INVENTION

It is known to improve the wet-skid resistance and the abrasion resistance by the use of terpolymers based on a conjugated diolefin, a vinyl aromatic compound and an olefinically unsaturated nitrile. See example, EP-A 537 640, U.S. Pat. Nos. 5,310,815 and 5,225,479, DE-A 3 837 047, DE-A 19 643 035 and EP-A 0 736 399. It is also known that the terpolymers disclosed therein may be mixed with other rubbers and with conventional rubber auxiliary substances. Among a very wide variety of rubber auxiliary substances, plasticizers are also described as auxiliary substances, which can be used in the conventional manner.

However, the terpolymers described in the mentioned patent publications, and mixtures thereof with other rubbers, are still in need of improvement in respect to dynamic properties, such as dynamic modulus at low temperatures, and in respect to the combination of the properties of rolling resistance, wet-skid resistance and abrasion. In tread mixtures containing carbon black or silica, the use of such terpolymers leads to a marked increase in the tan δ value at 0° C., which indicates improved wet-skid resistance. Improved abrasion resistance is also found, depending on the particular rubber mixture used. However, the use of the terpolymers in such mixtures also exhibits negative effects, such as markedly increased dynamic modulus at 0° C. and increased tan δ value at 60° C. However, a tire tread mixture having a high dynamic modulus at 0° C. has disadvantages at low temperatures in respect of the ABS braking behavior in wet conditions and in the case of the driving behavior. A high tan δ value at 60° C. also indicates higher rolling resistance.

The object of the present invention was to provide rubber mixtures, which exhibit an improvement in their physical properties, compared with the known quaternary polymers.

It has now been found that, compared with the prior art, rubber mixtures containing quaternary polymers based on an unsaturated olefinic nitrile, a vinyl aromatic compound, a conjugated diene and a polar polymerizable compound, as well as at least one polar synthetic plasticizer, exhibit improved dynamic properties, such as dynamic modulus at low temperatures, and an improved combination of the properties of rolling resistance, wet-skid behavior and abrasion resistance.

### SUMMARY OF THE INVENTION

The present invention accordingly provides rubber mixtures containing (a) at least one quaternary polymer prepared from an olefinically unsaturated nitrile, a vinyl aromatic compound, a conjugated diene and a polar polymerizable compound and (b) at least one polar synthetic plasticizer, wherein component b) is present in amounts of from 1 to 200 wt. %, based on the amount of the quaternary polymer (a).

### DETAILED DESCRIPTION OF THE INVENTION

Preference is given to rubber mixtures in which component b) is present in amounts of from 2 to 180 wt. %, especially from 5 to 150 wt. %, based on the amount of the quaternary polymer (a).

The quaternary polymer used as component a) in the rubber mixtures according to the present invention are prepared from unsaturated olefinic nitrites, vinyl aromatic compounds, conjugated dienes and a polar polymerizable compound. Suitable conjugated dienes include 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene or mixtures of the mentioned dienes. Preferably, conjugated dienes including 1,3-butadiene and 2-methyl-1,3-butadiene, more preferably 1,3-butadiene.

Suitable vinyl aromatic compounds contain from 8 to 16 carbon atoms in the molecule, such as styrene, α-methylstyrene, 2-methylstyrene, 3-methylstyrene, 4-methylstyrene, 2,4-dimethylstyrene, 2,4-diisopropylstyrene, 4-cyclohexylstyrene, 4-p-toluenestyrene, p-chlorostyrene, p-bromostyrene, 4-tert-butylstyrene, 1-vinylnaphthalene, 2-vinylnaphthalene or mixtures thereof, with styrene being preferred.

Suitable olefinically unsaturated nitriles for forming the quaternary polymers include acrylonitrile, methacrylonitrile, ethylacrylonitrile, crotononitrile, 2-pentenenitrile or mixtures thereof, with acrylonitrile being preferred.

Polar polymerizable compounds are preferably those which contain hydroxyl, epoxy, amide, amino and alkoxysilyl groups.

Suitable monomers containing amino and amide groups include any monomers that are polymerizable with the above-mentioned monomers and contain at least one amino group. The amino group may be of primary, secondary or tertiary nature. Preference is given to those monomers having a primary or tertiary amino group, more preferably to monomers having a tertiary amino group. The monomers containing amino groups may in turn be used alone or in combination with other monomers containing amino groups.

Suitable monomers having primary amino groups include those mentioned on page 3, lines 12 to 14, of EP-A 0 849 321. Such as, acrylamide, methacrylamide, p-aminostyrene, aminomethyl acrylate, aminomethyl methacrylate, aminoethyl acrylate, aminoethyl methacrylate, aminopropyl acrylate, aminopropyl methacrylate, aminobutyl acrylate and aminobutyl methacrylate.

Suitable amino-group-containing monomers having secondary amino groups include those mentioned on page 3, lines 15 to 19, of EP-A 0 849 321. Such as anilinostyrene, anilinophenylbutadiene, methylacrylamide, ethylacrylamide, methylmethacrylamide, ethylmethacrylamide, N-monosubstituted acrylamide, such as N-methylolacrylamide, and N-monosubstituted methacrylamide, such as N-(4-anilinophenyl)methacrylamide.

Suitable amino-group-containing monomers having tertiary amino groups include those listed in the mentioned European patent publication on page 3, lines 20 to 23. Such as N,N-disubstituted aminoalkyl acrylate, N,N-disubstituted aminoalkyl methacrylate, N,N-disubstituted aminoalkylacrylamide, N,N-disubstituted aminoalkylacrylmethamide, N,N-disubstituted amino-aromatic vinyl compounds, and vinyl compounds containing pyridyl groups.

Monomers containing amino groups include those mentioned on page 3, lines 24 to 56, of EP-A-0 849 321. Such as N,N-dimethylaminomethyl acrylate, N,N-dimethylaminomethyl methacrylate, N,N-dimethylaminoethyl acrylate, N,N-dimethylaminoethyl methacrylate, N,N-dimethylaminopropyl acrylate, N,N-dimethylaminopropyl methacrylate, N,N-dimethylaminobutyl acrylate, N,N-dimethylaminobutyl methacrylate, N-methyl-N-ethylaminoethyl acrylate, N-methyl-N-ethylaminoethyl methacrylate, N,N-dipropylaminoethyl acrylate, N,N-dipropylaminoethyl methacrylate, N,N-dibutylaminoethyl acrylate, N,N-dibutylaminoethyl methacrylate, N,N-dibutylaminopropyl acrylate, N,N-dibutylaminopropyl methacrylate, N,N-dibutylaminobutyl acrylate, N,N-dibutylaminobutyl methacrylate, N,N-dihexylaminoethyl acrylate, N,N-dihexylaminoethyl methacrylate, N,N-dioctylaminoethyl acrylate, N,N-dioctylaminoethyl methacrylate and acryloylmorpholine. Suitable acrylic acid esters include N,N-dimethylaminoethyl acrylate, N,N-diethylaminoethyl acrylate, N,N-dipropylaminoethyl acrylate, N,N-dioctylaminoethyl acrylate and N-methyl-N-ethylaminoethyl acrylate, and suitable methacrylic acid esters include N,N-dimethylaminomethyl methacrylate, N,N-diethylaminoethyl methacrylate, N,N-dipropylaminoethyl methacrylate. N,N-Dioctylaminomethyl methacrylate and N-methyl-N-ethylaminoethyl methacrylate are preferred.

Suitable N,N-disubstituted aminoalkylacrylamides and N,N-disubstituted aminoalkylmethacrylamides include N,N-dimethylaminomethylacrylamide, N,N-dimethylaminomethylmethacrylamide, N,N-dimethylaminoethylacrylamide, N,N-dimethylaminoethylmethacrylamide, N,N-dimethylaminopropylacrylamide, N,N-dimethylaminopropylmethacrylamide, N,N-dimethylaminobutylacrylamide, N,N-dimethylaminobutylmethacrylamide, N,N-diethylaminoethylacrylamide, N,N-diethylaminoethylmethacrylamide, N,N-diethylaminopropylacrylamide, N,N-diethylaminopropylmethacrylamide, N,N-diethylaminobutylacrylamide, N,N-diethylaminobutylmethacrylamide, N-methyl-N-ethyl-aminoethylacrylamide, N-methyl-N-ethyl-aminoethylmethacrylamide, N,N-dipropylaminoethylacrylamide, N,N-dipropylaminoethylmethacrylamide, N,N-dibutylaminoethylacrylamide, N,N-dibutylaminoethylmethacrylamide, N,N-dibutylaminopropylacrylamide, N,N-dibutylaminopropylmethacrylamide, N,N-dibutylaminobutylacrylamide, N,N-dibutylaminobutylmethacrylamide, N,N-dihexylaminoethylacrylamide, N,N-dihexylaminoethylmethacrylamide, N,N-dihexylaminopropylacrylamide, N,N-dihexylaminopropylmethacrylamide, N,N-dioctylaminopropylacrylamide and N,N-dioctylaminopropylmethacrylamide. Preferably, N,N-dimethylamino-propylacrylamide, N,N-dimethylaminopropylmethacrylamide, N,N-diethylaminopropylacrylamide, N,N-diethylaminopropylmethacrylamide, N,N-dioctylaminopropylacrylamide and N,N-dioctylaminopropylmethacrylamide.

Suitable N,N-disubstituted amino-aromatic compounds include N,N-dimethylaminoethylstyrene, N,N-diethylaminoethylstyrene, N,N-dipropylaminoethylstyrene and N,N-dioctylaminoethylstyrene.

Suitable compounds having pyridyl groups include 2-vinylpyridine, 4-vinylpyridine, 5-methyl-2-vinylpyridine and 2-ethyl-2-vinylpyridine. 2-Vinylpyridine and 4-vinylpyridine are preferred.

Suitable vinyl monomers containing hydroxyl and epoxy groups include any vinyl monomers that are polymerizable with the above-mentioned monomers and contain at least one hydroxyl or epoxy group. The hydroxyl groups of the monomers containing hydroxyl groups may be primary, secondary or tertiary hydroxyl groups. The vinyl monomers containing hydroxyl or epoxy groups can be used alone or in combination with other vinyl monomers containing hydroxyl or epoxy.

The vinyl monomers containing hydroxyl or epoxide groups include, for example, unsaturated carboxylic acid monomers, vinyl ether monomers, aromatic vinyl monomers, vinyl ketone monomers, glycidyl acrylates and glycidyl methacrylates, allyl ethers and methallyl ethers, as well as cyclohexane monoxide. The use of unsaturated carboxylic acid monomers is preferred. The unsaturated carboxylic acid monomers, such as acrylic acid, methacrylic acid, itaconic acid, fumaric acid and maleic acid, may be present, for example, in the form of their esters, amines and in the form of anhydrides. Acrylic acid esters and methacrylic acid esters containing hydroxyl groups are preferred.

Suitable monomers containing hydroxyl groups include hydroxymethyl (meth)acrylate, 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glycerol mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl-(meth)acrylamide, 2-hydroxyethyl(meth)acrylamide, 2-hydroxypropyl(meth)-acrylamide, 3-hydroxypropyl(meth)acrylamide, di-(ethylene glycol) itaconate, di-(propylene glycol) itaconate, bis-(2-hydroxypropyl) itaconate, bis-(2-hydroxy-ethyl) itaconate, bis-(2-hydroxyethyl) fumarate, bis-(2-hydroxyethyl) maleate, 2-hydroxyethyl vinyl ether, hydroxymethyl vinyl ketone, glycidyl (meth)acrylate and allyl alcohol. Preference is given to hydroxymethyl (meth)acrylate, 2-hydroxyethyl (meth)acrylate, 2-hydroxypropyl (meth)acrylate, 3-hydroxypropyl (meth)acrylate, 3-phenoxy-2-hydroxypropyl (meth)acrylate, glycerol mono(meth)acrylate, hydroxybutyl (meth)acrylate, hydroxyethyl (meth)acrylate, hydroxyoctyl (meth)acrylate, hydroxymethyl(meth)acrylamide, 2-hydroxyethyl(meth)acrylamide, 2-hydroxypropyl(meth)acrylamide, 3-hydroxypropyl(meth)acrylamide and glycidyl methacrylate. More preference is given to hydroxymethyl (meth)acrylate, 2-hydroxyethyl (meth)acrylate, 3-hydroxypropyl (meth)acryl ate and glycidyl methacryl ate. Such monomers containing hydroxyl groups are also described, for example, on page 4, lines 18 to 38, of EP-A 0 806 457.

Unsaturated amides containing hydroxyl groups, such as N-hydroxymethylacrylamide, N-hydroxymethylmethacrylamide, N-hydroxyethylacrylamide, N-hydroxyethylmethacrylamide, are also suitable.

Also suitable are polar polymerizable compounds having a carboxyl group, such as acrylic acid, methacrylic acid, itaconic acid, fumaric acid and maleic acid.

Likewise suitable are polar polymerizable compounds having an alkoxysilyl group, such as, for example, (meth)acryloxymethyltrimethoxysilane, (meth)acryloxymethylmethyldimethoxysilane, (meth)acryloxymethyldimethylmethoxysilane, γ-(meth)acryloxypropyltrimethoxysilane, γ-(meth)acryloxypropylmethyldimethoxysilane, γ-(meth)acryloxypropyldimethylmethoxysilane, γ-(meth)acryloxypropyltriethoxysilane, γ-(meth)acryloxypropyldimethylethoxysilane, γ-(meth)acryloxypropylmethyldipropoxysilane. 2,4,6,8-Tetramethyltetravinylcyclotetrasiloxane is also suitable.

The quaternary polymers to be used in the rubber mixtures according to the present invention contain the conjugated dienes in amounts of from 40 to 95 wt. %, preferably from 50 to 90 wt. %, more preferably from 55 to 85 wt. %, the vinyl aromatic compounds in amounts of from 1 to 30 wt. %, preferably from 5 to 30 wt. %, more preferably from 10 to 30 wt. %, the olefinically unsaturated nitriles in amounts of from 1 to 30 wt. %, preferably from 5 to 25 wt. %, more preferably from 9 to 20 wt. %, and the polar polymerizable compounds in amounts of from 0.1 to 20 wt. %, preferably from 0.5 to 15 wt. %, more preferably from 1 to 10 wt. %, most preferably from 1 to 6 wt. %, the sum of the amounts of the individual components being 100 wt. %.

Depending on the amounts of the structural components used, the glass transition temperature of the quaternary polymers used according to the present invention is approximately from −60 to 0° C., preferably from −45 to −15° C.

The quaternary polymers used in the rubber mixtures according to the present invention are prepared by known polymerization techniques. Emulsion polymerization is preferred.

As mentioned, it is desired for the physical properties of the rubber mixtures according to the present invention, or of the vulcanizates or molded bodies produced therefrom, that polar synthetic plasticizers be added to the rubber mixtures. Suitable as polar synthetic plasticizers include those which contain, for example, ester groups or ether groups in the molecule, for example phthalates, such as dibutyl phthalates (DBP), dioctyl phthalates (DOP), diisononyl phthalates (DINP), diisodecyl phthalates (DIDP), diisotridecyl phthalates (DTDP), diundecyl phthalates (DUP), sebacates, such as dioctyl sebacates (DOS), dibutyl sebacates (DBS), adipates, such as dioctyl adipates (DOA), diisodecyl adipates (DIDA), diisononyl adipates (DINA), di-(butoxy-ethoxy-ethyl) adipates, phosphoric acid esters, such as tricresyl phosphates (TCP), trixylyl phosphates (TXP), trioctyl phosphates (TOF), diphenylcresyl phosphates, diphenyloctyl phosphates, trichloroethyl phosphates, stearates, such as butyl stearate, azelates, such as dioctyl azelates, oleates, such as dibutyl oleate, trimellitates, such as trioctyl mellitate, tri-linear-C₇-C₉-trimellitates, glycolates, such as dibutylmethylene bis-thioglycolates, di-2-ethyl-hexyl ester thiodiglycolates, nylonates, such as dioctyl nylonate, diisodecyl nylonate, phenylalkyl-sulfonic acid esters, butyl-carbitol-formal, as well as mixed esters of adipic, glutaric and succinic acid.

Suitable polar plasticizers also include chlorinated paraffins having a chlorine content of from 40 to 70 wt. %, as well as epoxy-ester-based plasticizers, polyester- and polyether-based plasticizers, ether-thioether-based plasticizers, and plasticizers based on phenolsulfonic acid esters.

The polar synthetic plasticizers can be used either individually or in admixture with one another. The most advantageous mixing ratio is dependent on the particular intended use of the rubber mixtures according to the present invention.

Preference is given to plasticizers based on phthalic acid, sebacic acid and adipic acid of the above-mentioned type.

Of course, the rubber mixtures according to the present invention may contain, in addition to the polar synthetic plasticizers, also known fillers and rubber auxiliary substances, such as pigments, zinc oxide, stearic acid, vulcanization accelerators, vulcanizing agents, for example based on sulfur and peroxide, stabilizers, antioxidants, resins, oils, waxes as well as inhibitors.

Suitable fillers for the rubber mixtures according to the present invention are both the known carbon blacks and silicas and also silicates, titanium dioxide, chalk or clay or mixtures thereof. Carbon black and silica are preferably used as fillers.

When silicas are used in the rubber mixtures, so-called filler activators, such as bis-3-(triethoxysilylpropyl) tetrasulfite, can also be added in known manner.

The mentioned additives and auxiliary substances are also known to the person skilled in the art and are described, inter alia, in Kautschuk-Technology by Werner Hoffmann, postdoctoral thesis of the Faculty of Mechanical Engineering, TH Aachen, 1975; Handbuch für die Gummiindustrie bei Bayer AG Leverkusen, Hoffmann, W.: Kautschuk-Technology Stuttgart (Genter 1980) and in Helle Füllstoffe in Polymeren, Gummi Faser Kunststoffe 42 (1989) No. 11.

The fillers and the mentioned rubber auxiliary substances are used in the conventional amounts. The advantageous amounts for a particular case are dependent inter alia on the intended use of the rubber mixtures and can readily be determined by appropriate preliminary tests.

Of course, it is possible to add to the rubber mixtures according to the present invention also other natural rubbers (NR) as well as synthetic rubbers, such as, for example, polybutadiene (BR), styrene-butadiene copolymers (SBR), polyisoprene rubbers (IR), isoprene-butadiene rubbers, isoprene-butadiene-styrene rubbers, ethylene-propylene rubbers. Preference is given to the use of polybutadiene, styrene-butadiene copolymers and natural rubbers. Of course, oils based on aromatic, naphthenic or paraffinic compounds can also be added—as is usual—to the mentioned additional rubbers used in the rubber mixtures according to the present invention.

The synthetic rubbers that are additionally to be used are produced in known manner by free-radical emulsion polymerization, free-radical solution polymerization, anionic or cationic polymerization or by Ziegler-Natta polymerization.

The amount of additional rubbers added can be varied within wide limits and is dependent especially on the subsequent intended use of the rubber mixtures according to the invention based on quaternary polymers, such as functionalized NSBR, and synthetic plasticizers.

In general, the mentioned additional rubbers are used in amounts of from 5 to 95 wt. %, preferably from 10 to 90 wt. %, more preferably from 20 to 80 wt. %, based on the amount of rubber as a whole.

The rubber mixtures according to the present invention can be produced by mixing the individual components with one another intensively in suitable mixing units, such as rollers or kneaders.

The rubber mixtures according to the present invention are preferably produced by mixing component a), i.e. the quaternary polymer, in latex form with the polar synthetic plasticizer(s) (component b)) and working up the resulting mixture in the appropriate manner by coagulation and subsequent drying.

The addition of the plasticizers to the quaternary polymer latex can be carried out by simply mixing the two components. It is also possible to add the plasticizer in the form of an aqueous emulsion to the latex, with the addition of conventional known emulsifiers. It is possible to use those emulsifiers, which have also been used in the preparation of the latex. Of course, the use of other emulsifiers is also possible.

The preparation of the latex/plasticizer mixture can be carried out at room temperature or alternatively at a higher temperature, especially when the plasticizer to be added has a high viscosity.

Coagulation of the latex/plasticizer mixture can be effected by known and conventional processes. Examples thereof are the introduction of mechanical energy, with coagulation taking place by means of shear, by the use of purely thermal processes or by the addition of precipitating agents, such as alkali, alkaline earth or aluminum salts or inorganic or organic acids, the use of precipitation aids, such as gelatin and/or polyelectrolytes, additionally being possible. The use of precipitating agents and precipitation aids of the mentioned type is preferred.

The coagulated mixture can be subjected in known manner to one or more washing steps, with preliminary dehydration of the coagulated mixture in apparatuses suitable for that purpose, for example in a dehydration screw, being possible before drying.

The above-described further rubbers, fillers and rubber auxiliary substances can then be mixed with the resulting coagulated and dried mixture in a known manner.

The rubber mixtures according to the present invention can be vulcanized in the conventional manner, the most expedient vulcanization process being dependent on the particular intended use of the rubber mixtures.

The rubber mixtures according to the present invention can be used in the production of vulcanizates of any kind, especially in the production of tire components and in the production of industrial rubber articles, such as belts, gaskets and hoses.

The rubber mixtures according to the present invention are preferably used in tire construction, especially for tire treads.

In the following Examples, the properties of the rubber mixtures according to the invention, of the comparison rubber mixtures and of the resulting vulcanizates have been measured as follows:

(1) The polymer composition was measured by means of IR spectroscopy.

(2) The Mooney viscosity of the rubbers was determined according to DIN 53523.

(3) The tensile strength of the vulcanizates was determined according to DIN 53504.

(4) The ultimate elongation of the vulcanizates was determined according to DIN 53504.

(5) The modulus of the vulcanizates at 100% and 300% elongation was determined according to DIN 53504.

(6) The hardness of the vulcanizates at 23° C. and 70° C. was determined according to DIN 53505.

(7) The abrasion of the vulcanizates was determined according to DIN 53516.

(8) The tan δ of the vulcanizates was determined according to DIN 53513.

The invention is further illustrated but is not intended to be limited by the following examples in which all parts and percentages are by weight unless otherwise specified.

### EXAMPLES

Production of the Rubbers

Rubber A:

1416.38 g of styrene, 16.59 g of tert-dodecylmercaptan, 900 g of acrylonitrile, 214.88 g of 2-hydroxyethyl methacrylate and a solution consisting of 7537.5 g of demineralized water, 197.44 g of disproportionated rosin acid (sodium salt, 70%), 2175 g of partially hydrogenated tallow fatty acid (potassium salt, 9%), 14.06 g of potassium hydroxide (85%), 32.06 g of condensed naphthalenesulfonic acid (Na salt) and 14.63 g of potassium chloride were placed in an evacuated, stirrable 20 liter steel reactor. All the components were flushed with nitrogen beforehand. 3093.8 g of butadiene were then added, and the emulsion was adjusted to a temperature of 10° C. with stirring. Polymerization was started by addition of 1.01 g of p-menthane hydroperoxide (50%) and of a solution consisting of 111.94 g of demineralized water, 1.13 g of EDTA, 0.90 g of iron (II) sulfate * 7H₂O, 2.31 g of sodium formaldehyde sulfoxylate and 3.49 g of sodium phosphate * 12H₂O, the components introduced initially being rinsed with 384.75 g of demineralized water, and the polymerization was continued at 10° C. with stirring.

At a conversion of 78.6%, the polymerization was stopped by addition of 22.5 g of diethylhydroxylamine (25%) and 1.13 g of sodium dithionite. 13.5 g of Vulkanox® BKF (2,2′-methylene-bis-(4-methyl-6-tert-butylphenol, from Bayer AG Leverkusen), added in the form of a 47.7% dispersion (28.3 g), were added to the latex. The unreacted butadiene was degassed and the unreacted monomers were removed from the latex by means of steam. 80 liters of demineralized water (60° C.) were added to the degassed latex with stirring, and precipitation was effected at 60° C. by addition of 3.38 kg of sodium chloride and 113 g of polyamine (Superfloc® C567, 10%) at pH 4 with addition of 10% sulfuric acid. The resulting polymer was filtered off and washed with demineralized water at 65° C. with stirring. The moist rubber was dried at 70° C. in a vacuum drying cabinet to a residual moisture content of <0.5%. The polymer had a Mooney viscosity (ML 1+4) of 51. The contents of butadiene, styrene and 2-hydroxyethyl methacrylate were measured by means of 1H-NMR and were 60.3, 18.7 and 2.6 wt. %. The acrylonitrile content was determined by means of nitrogen content and was 18.5 wt. %. The gel content in toluene was 2.9%.

Several functionalized rubbers (Rubber's B, C and D) were produced in the same manner. The formulations and the results of the characterization are listed in Table 1.

TABLE 1

| | Rubber | Rubber | Rubber | Rubber | Rubber |
|---|---|---|---|---|---|
| | A | B | C | D | E |
| | wt. % | wt. % | wt. % | wt. % | wt. % |
| Monomers used | | | | | |
| Butadiene | 55.00 | 55.00 | 55.00 | 55.00 | 56.00 |
| Styrene | 25.18 | 25.14 | 25.14 | 25.18 | 33.00 |
| Acrylonitrile | 16.00 | 16.00 | 16.00 | 16.00 | 8.00 |
| 2-Hydroxyethyl methacrylate | 3.82 | | | | |
| Dimethylaminopropylmethacrylamide | | 3.86 | | | |
| Dimethylaminopropylmethacrylamide | | | 3.86 | | |
| 2-Hydroxyethyl methacrylate | | | | 3.82 | |
| Dimethylaminopropylmethacrylamide | | | | | 3.00 |
| Total monomers | 100.00 | 100.00 | 100.00 | 100.00 | 100.00 |
| Mooney viscosity (ME) | 51 | 46 | 128 | 120 | 47 |
| Gel content in toluene (%) | 2.9 | 1.5 | 3.7 | 2.2 | 2.8 |
| Polymer composition | | | | | |
| Butadiene | 60.3 | 60.4 | 62.3 | 61.5 | 63.0 |
| Styrene | 18.7 | 20.9 | 17.9 | 17.1 | 26.3 |
| Acrylonitrile | 18.4 | 17.1 | 18.8 | 18.4 | 10.1 |
| 2-Hydroxyethyl methacrylate | 2.6 | | | 3.0 | |
| Dimethylaminopropylmethacryl- | | 1.6 | | | |
| amide | | | | | |
| Dimethylaminopropylmethacryl- | | | 1.0 | | |
| amide | | | | | |
| 2-Hydroxyethyl methacrylate | | | | 3.0 | |
| Dimethylaminopropylmethacryl- | | | | | 0.6 |
| amide | | | | | |
| Total | 100.0 | 100.0 | 100.0 | 100.0 | 100.0 |

The following components were used for the comparison rubber mixtures and for the rubber mixtures according to the invention:

NSBR 1 (rubber produced by emulsion polymerization, 58.5% butadiene, 20.3% styrene and 21.1% acrylonitrile, Mooney viscosity 49),

NSBR 2 (rubber produced by emulsion polymerization, 62.1% butadiene, 26.8% styrene and 11.1% acrylonitrile, Mooney viscosity 51),

SBR 1500: Krylene® 1500 (emulsion SBR, 23.5% styrene, manufacturer Bayer Elastomeres),

NR (natural rubber TSR 5, cis 1,3-polyisoprene),

Buna VSL 5025-0 HM (solution SBR, vinyl content 50%, styrene content 25%, manufacturer Bayer Elastomeres),

Buna VSL 2525-0 (solution SBR, vinyl content 25%, styrene content 25%, manufacturer Bayer Elastomeres),

Buna CB 24 butadiene rubber (manufacturer Bayer AG),

Buna CB 25 butadiene rubber (manufacturer Bayer AG),

Enerthene 1849-1® (mineral oil plasticizer, manufacturer Mobil Schmierstoff GmbH),

Vulkasil S (active silica, product of Bayer AG),

Coraxo® N339 (carbon black, manufacturer Degussa Hüls AG),

Coraxe® N347 (carbon black, manufacturer Degussa Hüls AG),

Si 69 (bis-3-(triethoxysilylpropyl) tetrasulfide, manufacturer Degussa AG),

stearic acid,

ZnO (zinc oxide),

sulfur,

Vulkanox® 4010 Na (N-isopropyl-N′-phenyl-p-phenylenediamine, manufacturer Bayer AG),

Vulkanox® 4020 (N-(1,3-dimethylbutyl)-N′-phenyl-p-phenylenediamine, manufacturer Bayer AG),

Antilux 654® (light-stabilising wax, manufacturer Rhein-Chemie GmbH),

Vulkanox® HS (2,2,4-trimethyl-1,2-dihydroquinoline, polymerized, manufacturer Bayer AG),

Vulkacit® NZ (N-tert-butyl-benzothiazyl-sulfenamide, manufacturer Bayer AG),

Vulkacit® D (diphenylguanidine, manufacturer Bayer AG),

Vulkacit® CZ/C (N-cyclohexyl-2-benzothiazyl-sulfenamide, manufacturer Bayer AG),

DOP: Vestinol AH, (dioctyl phthalate, Hüls AG),

DOS: Edenol 888, (dioctyl sebacate, Henkel KGaA).

The carbon black mixtures were mixed in a kneader (Werner & Pfleiderer GK 1.5) at 50 rpm. The kneader temperature was 50° C. and the degree of filling was 70%. The mixture was mixed in one step. The discharge temperature was 125° C. The vulcanization accelerators were mixed in on a roller.

The silica mixtures were mixed in a kneader (Werner & Pfleiderer GK 1.5) at 70 rpm. The kneader temperature was 70° C. and the degree of filling was 72%. In this case, mixing was carried out in two steps. In the first step, the polymers, silica, mineral oil and silane were mixed. The discharge temperature was 150° C. In the second step, the remaining constituents of the mixture, including the crosslinking chemicals, were added; the discharge temperature was 95° C. Homogenisation was subsequently carried out on a roller.

The mixtures and the results of the tests are listed in Tables 2 and 5.

TABLE 2

| | Compar- | Compar- | | |
|---|---|---|---|---|
| | ison | ison | Example | Example |
| | Example 1 | Example 2 | 1 | 2 |
| Buna VSL-5025-0 HM | 9 | 9 | 9 | 9 |
| NSBR 1 | 45 | 0 | 0 | 0 |
| Rubber A | 0 | 45 | 45 | 0 |
| Rubber B | 0 | 0 | 0 | 45 |
| Buna CB 24 | 36 | 36 | 36 | 36 |
| TSR 5 Defo 700 | 10 | 10 | 10 | 10 |
| Vulkasil S | 70 | 70 | 70 | 70 |
| Si 69 | 5.6 | 5.6 | 5.6 | 5.6 |
| Enerthene 1849-1 | 37.5 | 37.5 | 20 | 20 |
| DOP | 0 | 0 | 17.5 | 17.5 |
| ZnO | 2.5 | 2.5 | 2.5 | 2.5 |
| Stearic acid | 1 | 1 | 1 | 1 |
| Antilux 654 | 1.5 | 1.5 | 1.5 | 1.5 |
| Vulkanox HS | 1 | 1 | 1 | 1 |
| Vulkanox 4020 | 1 | 1 | 1 | 1 |
| Vulkacit CZ | 1.8 | 1.8 | 1.8 | 1.8 |
| Vulkacit D | 2 | 2 | 2 | 2 |
| Sulfur | 1.5 | 1.5 | 1.5 | 1.5 |
| Vulcanate properties | | | | |
| Tensile strength (MPa) | 18.6 | 15.4 | 16.1 | 17.8 |
| Ultimate elongation (%) | 545 | 425 | 460 | 495 |
| Modulus 100% (MPa) | 2.9 | 3.3 | 3.1 | 3.0 |
| Modulus 300% (MPa) | 8.8 | 10.0 | 9.4 | 9.5 |
| Hardness 23° C. | 68 | 71 | 69 | 71 |
| (Shore A) | | | | |
| Hardness 70° C. | 65 | 67 | 66 | 67 |
| (Shore A) | | | | |
| DIN abrasion P-60 | 66 | 67 | 67 | 55 |
| (mm3) | | | | |
| tan δ 0° C. | 0.421 | 0.430 | 0.371 | 0.428 |
| tan δ 23° C. | 0.303 | 0.285 | 0.234 | 0.234 |
| tan δ 60° C. | 0.151 | 0.157 | 0.138 | 0.144 |
| Complex modulus | | | | |
| E* at 0° C. | 111.230 | 75.265 | 37.060 | 36.832 |
| E* at 23° C. | 19.027 | 19.971 | 17.806 | 17.528 |
| E* at 60° C. | 11.239 | 11.366 | 11.670 | 11.841 |
| Storage modulus | | | | |
| E′ at 0° C. | 102.522 | 69.143 | 34.744 | 33.862 |
| E′ at 23° C. | 18.211 | 19.208 | 17.337 | 17.068 |
| E′ at 60° C. | 11.113 | 11.228 | 11.560 | 11.719 |
| Loss modulus | | | | |
| E″ at 0° C. | 43.144 | 29.734 | 12.897 | 14.490 |
| E″ at 23° C. | 5.511 | 5.466 | 4.057 | 3.987 |
| E″ at 60° C. | 1.675 | 1.766 | 1.594 | 1.691 |

Compared with the prior art (Comparison Examples 1 and 2), the rubber mixtures according to the present invention, while having comparable mechanical properties, exhibit advantages in respect of the properties rolling resistance (tan δ 60° C.) and in some cases also abrasion (see Table 2). The tan δ value at 0° C. does not achieve the prior art value in all cases but, as the person skilled in the art knows, a high tan δ at 0° C. does not guarantee good wet-skid resistance because, with a simultaneously high dynamic modulus at 0° C., disadvantages are found at low temperatures in respect of the ABS braking behavior in wet conditions and also in the case of the driving behavior.

TABLE 3

| | Comparison | |
|---|---|---|
| | Example 3 | Example 3 |
| Buna VSL 2525-0 | 25 | 25 |
| Buna CB 25 | 30 | 30 |
| Rubber A | 45 | 45 |
| Carbon black N-347 | 60 | 60 |
| Enerthene 1849-1 | 20 | 10 |
| DOP | 0 | 10 |
| ZnO | 2.5 | 2.5 |
| Stearic acid | 0.5 | 0.5 |
| Vulkanox 4020 | 1.2 | 1.2 |
| Vulkacit NZ | 1.5 | 1.5 |
| Sulfur | 2 | 2 |
| Antilux 654 | 2.5 | 2.5 |
| Vulcanate properties | | |
| Tensile strength (MPa) | 18.3 | 18.1 |
| Ultimate elongation (%) | 347 | 330 |
| Modulus 100 (MPa) | 4.1 | 4.1 |
| Modulus 300 (MPa) | 15.7 | 16.5 |
| Hardness 23° C. (Shore A) | 69 | 69 |
| Hardness 70° C. (Shore A) | 64 | 65 |
| DIN abrasion P-60 | 65 | 65 |
| (mm3) | | |
| tan δ 0° C. | 0.493 | 0.462 |
| tan δ 23° C. | 0.306 | 0.274 |
| tan δ 60° C. | 0.183 | 0.173 |
| Complex modulus | | |
| E* at 0° C. | 56.052 | 32.092 |
| E* at 23° C. | 15.926 | 14.076 |
| E* at 60° C. | 9.000 | 8.614 |
| Storage modulus | | |
| E′ at 0° C | 50.265 | 29.130 |
| E′ at 23° C. | 15.229 | 13.577 |
| E′ at 60° C. | 8.854 | 8.488 |
| Loss modulus | | |
| E″ at 0° C. | 24.805 | 13.466 |
| E″ at 23° C. | 4.659 | 3.715 |
| E″ at 60° C. | 1.616 | 1.467 |

Compared with the use of functionalized NSBR without addition of polar synthetic plasticizers (Comparison Example 3), the rubber mixtures according to the present invention, while having comparable mechanical properties, exhibit advantages in respect of rolling resistance (tan δ 60° C.). Although the tan δ value at 0° C. is slightly lower in the Example according to the present invention, the dynamic modulus at 0° C. is markedly lower (see Table 3). As the person skilled in the art knows, a high tan δ at 0° C. does not guarantee good wet-skid resistance because, with a simultaneously high dynamic modulus at 0° C., disadvantages are found at low temperatures in respect of the ABS braking behavior in wet conditions and also in the case of the driving behavior.

Production of the Rubber Mixtures According to the Invention by the Latex Method:

In order to produce the rubber mixtures according to the invention by the latex method, the latices of rubbers C and D (see Table 1) were used.

From the latex of rubber C there is obtained the rubber/DOS masterbatch 1, and from the latex of rubber D there is obtained the rubber/DOP masterbatch 2.

Production of the Latex/Plasticizer Mixture:

375 g of DOS (37.5 phr) were added to 3164.6 g of the latex of rubber C (31.6%), corresponding to 1000 g of polymer. To that end, the DOS was emulsified, with stirring, in an aqueous solution consisting of 464.91 g of water, 0.56 g of polynaphthalenesulfonic acid, 81.19 g of disproportionated rosin acid, sodium salt (10%), and 15.84 g of partially hydrogenated tallow fatty acid (potassium salt, 9%). The latex and the DOS emulsion were heated to 60° C. and mixed together with stirring. Stirring was carried out for 30 minutes.

Coagulation of the Latex/Plasticizer Mixture:

17 liters of demineralized water heated to 65° C., 750 g of sodium chloride and 25 g of polyamine (Superfloc® C567, 10%) were placed in a stirred vessel. The latex/plasticizer mixture was added at 65° C. with stirring. The pH value of the precipitating serum was adjusted to and maintained at 4 by addition of 10% sulfuric acid.

The precipitating serum was clear. The DOS-extended rubber was filtered off and washed for 15 minutes, with stirring, with 17 liters of demineralized water heated to 65° C. The moist rubber/DOS masterbatch 1 was dried at 70° C. in a vacuum drying cabinet. The Mooney viscosity of the (ML 1+4) was 29 ME.

The rubber/DOP masterbatch 2 with 37.5 phr DOP was produced in the same manner. The Mooney viscosity of the (ML1+4) was 39 ME.

The results are summarized in Table 4.

TABLE 4

| | Compar- | Compar- | | |
|---|---|---|---|---|
| | ison | ison | Example | Example |
| | Example 4 | Example 5 | 4 | 5 |
| SBR 1500 | 100 | 53.33 | 53.33 | 53.33 |
| NSBR 1 | 0 | 46.67 | 0 | 0 |
| Rubber/DOS masterbatch | 0 | 0 | 64.17 | 0 |
| 1 | | | | |
| Rubber/DOP masterbatch | 0 | 0 | 0 | 64.17 |
| 2 | | | | |
| Carbon black N-339 | 50 | 50 | 50 | 50 |
| Enerthene 1849-1 | 30 | 30 | 12.5 | 12.5 |
| Stearic acid | 2 | 2 | 2 | 2 |
| ZnO | 3 | 3 | 3 | 3 |
| Vulkanox 4010 NA | 1 | 1 | 1 | 1 |
| Vulkanox 4020 | 1 | 1 | 1 | 1 |
| Sulfur | 2 | 2 | 2 | 2 |
| Vulkacit CZ | 1.5 | 1.5 | 1.5 | 1.5 |
| Vulkacit D | 0.2 | 0.2 | 0.2 | 0.2 |
| Parts by wt. DOS in the | 0 | 0 | 17.5 | 0 |
| mixture | | | | |
| Parts by wt. DOP in the | 0 | 0 | 0 | 17.5 |
| mixture | | | | |
| (based on total rubber) | | | | |
| Parts by wt. NSBR or | 0 | 46.67 | 46.67 | 46.67 |
| functionalized NSBR in | | | | |
| the mixture | | | | |
| (based on total rubber) | | | | |
| Vulcanate properties | | | | |
| Tensile strength (MPa) | 21.6 | 22.6 | 21.6 | 23.6 |
| Ultimate elongation (%) | 625 | 585 | 515 | 525 |
| Modulus 100% (MPa) | 1.4 | 1.9 | 1.8 | 2.0 |
| Modulus 300% (MPa) | 6.7 | 8.4 | 9.7 | 10.1 |
| Hardness 23° C. | 53 | 58 | 57 | 59 |
| (Shore A) | | | | |
| Hardness 70° C. | 50 | 51 | 52 | 53 |
| (Shore A) | | | | |
| DIN abrasion P-60 | 130 | 105 | 70 | 75 |
| (mm3) | | | | |
| tan δ 0° C. | 0.302 | 0.601 | 0.485 | 0.614 |
| tan δ 23° C. | 0.228 | 0.332 | 0.238 | 0.252 |
| tan δ 60° C. | 0.165 | 0.196 | 0.158 | 0.158 |
| Complex modulus | | | | |
| E* at 0° C. | 9.618 | 90.912 | 15.354 | 21.692 |
| E* at 23° C. | 6.516 | 10.064 | 8.12 | 8.523 |
| E* at 60° C. | 4.638 | 5.845 | 5.786 | 5.799 |
| Storage modulus | | | | |
| E′ at 0° C. | 9.209 | 77.936 | 13.813 | 18.485 |
| E′ at 23° C. | 6.353 | 9.55 | 7.898 | 8.265 |
| E′ at 60° C. | 4.577 | 5.736 | 5.715 | 5.729 |
| Loss modulus | | | | |
| E″ at 0° C. | 2.778 | 46.809 | 6.705 | 11.351 |
| E″ at 23° C. | 1.449 | 3.174 | 1.884 | 2.079 |
| E″ at 60° C. | 0.755 | 1.123 | 0.903 | 0.904 |

The results in Table 4 show that, compared with a commercially available ESBR (Comparison Example 4), the rubber mixtures according to the present invention exhibit advantages in respect of rolling resistance (tan δ 60° C.) and in respect of wet-skid resistance (tan δ 0° C.), the values of the dynamic modulus at 0° C. not being too high. The abrasion of the rubber mixtures according to the present invention is markedly lower.

Compared with a NSBR (Comparison Example 5), the rubber mixtures according to the present invention exhibit advantages in respect of abrasion and in respect of rolling resistance (tan δ 60° C.). The tan δ value at 0° C. does not achieve the prior art value in all cases but, as the person skilled in the art knows, a high tan δ at 0° C. does not guarantee good wet-skid resistance because, with a simultaneously high dynamic modulus at 0° C., disadvantages are found at low temperatures in respect of the ABS braking behavior in wet conditions and also in the case of the driving behavior.

TABLE 5

| | Comparison | |
|---|---|---|
| | Example 6 | Example 6 |
| SBR 1500 | 70 | 70 |
| NSBR 2 | 30 | 0 |
| Rubber E | 0 | 30 |
| Carbon black N-339 | 50 | 50 |
| Enerthene 1849-1 | 30 | 15 |
| DOS | 0 | 15 |
| Stearic acid | 2 | 2 |
| ZnO | 3 | 3 |
| Vulkanox 4010 NA | 1 | 1 |
| Vulkanox 4020 | 1 | 1 |
| Sulfur | 2 | 2 |
| Vulkacit CZ | 1.5 | 1.5 |
| Vulkacit D | 0.2 | 0.2 |
| Vulcanate properties | | |
| Tensile strength (MPa) | 16.5 | 12.7 |
| Ultimate elongation (%) | 470 | 370 |
| Modulus 100% (MPa) | 2.1 | 2.3 |
| Modulus 300% (MPa) | 9.3 | 9.7 |
| Hardness 70° C. | 58 | 58 |
| Hardness 23° C. | 52 | 54 |
| DIN abrasion P-60 | 170 | 135 |
| (mm3) | | |
| tan δ 0° C. | 0.726 | 0.582 |
| tan δ 23° C. | 0.355 | 0.265 |
| tan δ 60° C. | 0.182 | 0.168 |
| Complex modulus | | |
| E* at 0° C. | 64.763 | 20.546 |
| E* at 23° C. | 9.794 | 8.425 |
| E* at 60° C. | 5.395 | 5.685 |
| Storage modulus | | |
| E′ at 0° C. | 52.410 | 17.760 |
| E′ at 23° C. | 9.230 | 8.144 |
| E′ at 60° C. | 5.308 | 5.606 |
| Loss modulus | | |
| E″ at 0° C. | 38.045 | 10.330 |
| E″ at 23° C. | 3.277 | 2.159 |
| E″ at 60° C. | 0.966 | 0.943 |

The results in Table 5 show that it is possible to vary the polymer composition of the quaternary polymers in the rubber mixtures according to the present invention without losing the advantages. A rubber mixture according to the present invention containing a quaternary polymer having a lower acrylonitrile content than the quaternary polymers of the rubber mixtures according to the present invention exhibits advantages, compared with the prior art (Comparison Example 6), in terms of rolling resistance (tan δ 60° C.) and in terms of abrasion. At the same time, the dynamic modulus at 0° C. is markedly lower in the case of Example 6 according to the invention.

Although the present invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A rubber mixture comprising
a) at least one quaternary polymer prepared from an olefinically unsaturated nitrile, a vinyl aromatic compound, a conjugated diene and a polar polymerizable compound and
b) at least one polar synthetic plasticizer, wherein component (b) is present in an amount of from 1 to 200 wt. %, based on the amount of the quaternary polymer (a).

2. The rubber mixture according to claim 1, wherein component (b) is present in an amount of from 2 to 180 wt. %, based on the amount of the quaternary polymer (a).

3. The rubber mixture according to claim 2, wherein component (b) is present in an amount of from 5 to 150 wt. %, based on the amount of the quaternary polymer (a),

4. The rubber mixture according to claim 1, wherein the conjugated diene is selected from the group consisting of 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene and mixtures thereof.

5. The rubber mixture according to claim 1, wherein the olefinically unsaturated nitrile is selected from the group consisting of acrylonitrile, methacrylonitrile, ethylacrylonitrile, crotononitrile, 2-pentenenitrile and mixtures thereof.

6. The rubber mixture according to claim 1, wherein the vinyl aromatic compound is selected from the group consisting of styrene, α-methylstyrene, 2-methylstyrene, 3-methylstyrene, 4-methylstyrene,

7. 2,4-dimethylstyrene, 2,4-diisopropylstyrene, 4-cyclohexylstyrene,

8. 4-p-toluenestyrene, p-chlorostyrene, p-bromostyrene, 4-tert-butylstyrene, 1-vinylnaphthalene, 2-vinylnaphthalene or mixtures thereof.

9. The rubber mixture according to claim 1, wherein the polar polymerizable compounds comprise hydroxyl, epoxy, amide, amino or alkoxysilyl groups.

10. The rubber mixture according to claim 7, wherein the polar polymerizable compound is selected from the group consisting of 2-hydroxyethyl methacrylate, dimethylaminopropylmethacrylamide or mixture thereof.

11. The rubber mixture according to claim 1, wherein the quaternary polymer is prepared from 40 to 95 wt. % of the conjugated diene, 1 to 30 w. % of the vinyl aromatic, 1 to 30 wt. % of the olefinically unsaturated nitrile, 0.1 to 20 wt. % of the polar polymerizable compound, based on a total weight percent of 100.

12. The rubber mixture according to claim 1, wherein the plasticizer is selected from the group consisting of phthalates, sebacates, adipates, phosphoric acid esters, stearates, azelates, oleates, trimellitates, glycolates, nylonates, and mixed esters of adipic, glutaric and succinic acid.

11. The rubber mixture according to claim 10, wherein the plasticizer is selected from the group consisting of phthalic acid, sebacic acid and adipic acid.

12. The rubber mixtures according to claim 1, further comprising at least one further synthetic or natural rubber or mixtures thereof, wherein the amount of added rubber is from 5 to 95 wt. %, based on the amount of rubber as a whole.

13. A rubber vulcanizate comprising a rubber mixture according to claim 1.

14. A process for preparing a rubber mixture according to claim 1, comprising the step of mixing component (a) and (b).

15. A process for preparing a rubber mixture according to claim 1, comprising the steps of mixing component (a) in latex form with component (b), coagulating the resulting mixture and drying the resulting mixture.
